(19) United States
(12) Patent Application Publication
(10) Pub. No.: US 2002/0131475 A1
(43) Pub. Date: Sep. 19, 2002

(54) Temperature sensor

(76) Inventors: Kyung Chul Woo, Seoul (KR); Byung Keol Choi, Seoul (KR)

Correspondence Address: BIRCH STEWART KOLASCH & BIRCH, PO BOX 747, FALLS CHURCH, VA, 22040-0747, US

(21) Appl. No.: 10/059,311

(22) Filed: Jan. 31, 2002

(30) Foreign Application Priority Data
Mar. 14, 2001 (KR) 13242/2001

(51) Int. Cl. G01K 1/14; G01K 13/00

(52) U.S. Cl. 374/141; 374/120

(57) ABSTRACT

The present invention relates a water temperature sensor of indirect/direct contact types for measuring a water temperature by using a chamber cap formed don the one side of a water gauge chamber of an automatic washing machine. The water temperature sensor includes a temperature measuring part for measuring a temperature of water; and a hollow chamber cap located at the bottom edge of a water gauge chamber within a washing machine, having a scating portion on a predetermined place for installing the temperature measuring part.

### BACKGROUND OF THE INVENTION

1. Field of the Invention

The present invention generally relates to a water temperature sensor, more particularly, to a temperature sensor capable of accurately measuring a temperature of washing water by using a chamber cap of a water gauge chamber within a washing machine.

2. Description of the Related Art

Generally speaking, most washing machines have a water temperature sensor. This is due to the automation of a washing machine, a control part as the heart of such automation requires a sensor. Such a sensor considerably affects the control part of the washing machine according to the property and the measuring method thereof, and consequently affects the whole performance of the washing machine. Therefore, the sensor has to be designed to achieve stable and accurate actions thereof.

In present, in the case of drum type washing machines or dish washing machines, the temperature of washing water is measured by inserting a metal probe into a water tub. On the other hand, in the case of other general washing machines, such the water tub is made of plastics instead of metal consisting the drum type washing machines. Therefore, if the metal probe is inserted into the plastic water tub, scaling work thereof is in a difficult situation more than the drum type washing machine. In order to solve this scaling problem, the general washing machine adopts a water temperature sensor attached to a water tap.

However, by measuring the temperature of water at the water tap in which hot water and cold water cross each other, there is need to change the flow passage of supplied water. Also, there is a problem that the measured value obtained from the water tap is different with the temperature of water actually used in washing.

### SUMMARY OF THE INVENTION

The present invention has been made to overcome the above-described problems. Accordingly, it is an object of the present invention to provide a temperature sensor, which can accurately measure a temperature of washing water by using a camber cap of a water gauge chamber within a washing machine.

To achieve the above objects, there is provided a water temperature sensor includes a temperature measuring part for measuring a temperature of water; and a hollow chamber cap located at the bottom edge of a water gauge chamber within a washing machine, having a seating portion on a predetermined place for installing the temperature measuring part.

Also, there is provided a water temperature sensor includes a temperature measuring part including a temperature detecting sensor for measuring the temperature of water, and signal lines for connecting the temperature detecting sensor with a circuit requiring the measured value; and a hollow chamber cap located at the bottom edge of the water gauge chamber, having a recess underneath the top surface thereof to mount the temperature measuring part within the hollow chamber cap, so that the water temperature is measured without directly contacting with water.

Further, there is provided to a water temperature sensor includes a temperature measuring part including a temperature detecting sensor for measuring the temperature of water, signal lines for connecting the temperature detecting sensor with a circuit requiring the measured value, and a cylindrical probe containing the temperature detecting sensor and the signal lines; and a hollow chamber cap, located on the bottom edge of the water gauge chamber, having a hole at the center thereof so that the cylindrical probe of the temperature measuring part is directly contacted with the washing water after penetrating the hole.

Furthermore, there is provided to a water temperature sensor includes an outer tube of a washing machine; a drain connector connected to said outer tub; a valve connected to said drain connector, for opening an closing by a motor; and a sensor installed between said outer tub and the upper side of said valve, for directly measuring the temperature of washing water collected upstream of said valve when said valve is closed during washing.

Since the temperature measuring part of the water temperature sensor is mounted within the chamber cap leveled to the bottom surface of the outer tub, it is possible to accurately measure the temperature of the water actually used in washing, thereby the effective and reliable washing being achieved. In addition, since it is possible to accurately measure the water temperature only by processing the chamber cap without requiring a separate process, the structure and the assembly thereof can be simplified and the cost of production can be reduced.

### BRIEF DESCRIPTION OF THE DRAWINGS

FIG. 1 is a state diagram showing a state that a chamber cap capable of receiving a water temperature sensor is mounted on a washing machine in accordance with a preferred embodiment of the present invention.

FIG. 2a is a longitudinal sectional view illustrating a water temperature sensor of indirect contact type in accordance with a preferred embodiment of the present invention.

FIG. 2a is a perspective view illustrating the water temperature sensor of indirect contact type in accordance with the preferred embodiment of the present invention.

FIG. 3a is a longitudinal sectional view illustrating a water temperature sensor of direct contact type in accordance with a preferred embodiment of the present invention.

FIG. 3b is a perspective view illustrating the water temperature sensor of direct contact type in accordance with the preferred embodiment of the present invention.

FIG. 4 is a schematic view illustrating the installation position of a water temperature sensor in accordance with another embodiment of the present invention.

### DETAILED DESCRIPTION OF THE PREFERRED EMBODIMENT

A preferred embodiment in accordance with the present invention will now be described in more detail with reference to the accompanying drawing.

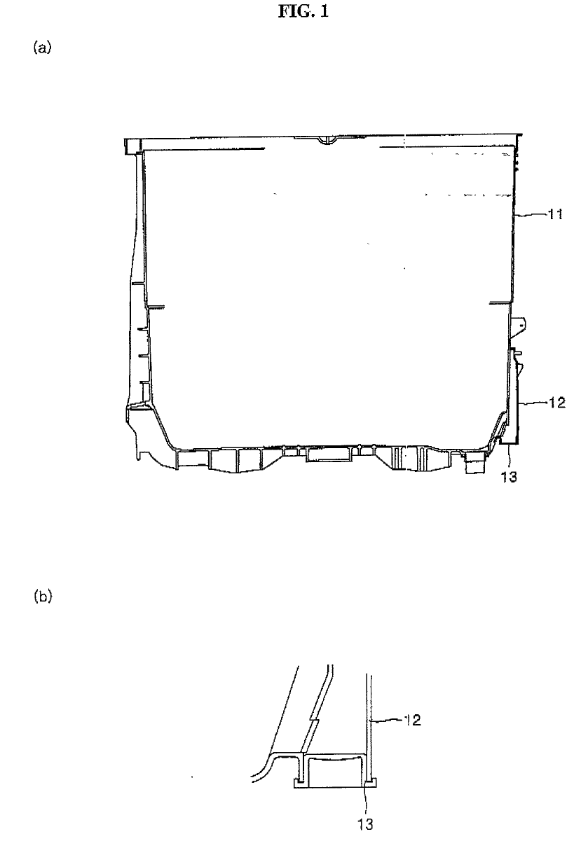

FIG. 1 is a state diagram showing a state that a chamber cap capable of receiving a water temperature sensor is mounted on a washing machine in accordance with a preferred embodiment of the present invention.

As can be seen in FIG. 1, a water gauge chamber 12 is upwardly extended along the one side of an outer tub 11 of a washing machine from the bottom edge of the outer tub. A pressure sensor is connected to an L-shaped projection formed near the top edge of the water gauge chamber 12. The level of water can be measured by using the variation of air pressure due to the level of water to be applied to the pressure sensor.

Since water gauge chamber 12 is constructed to have an opened bottom portion considering the difficulties of manufacture, a hollow chamber cap 13, generally made of a same material with a cleansing basket of the washing machine, is used to close the opened bottom portion of the water gauge chamber 12 in order to prevent a water leakage after the assembly of the water gauge chamber. The hollow chamber cap is fastened to the water gauge chamber 12 by way of an ultrasonic welding method.

Since the bottom edge of the hollow chamber cap 13 is almost leveled to the bottom surface of the outer tub, the hollow chamber cap can directly contact with water used in washing.

Therefore, by installing the temperature measuring part capable of measuring the water temperature to a certain region of the hollow chamber cap 13 to be directly contact with the water used in washing, it is possible to accurately measure the temperature of washing water.

The temperature measuring part includes a temperature detecting sensor for measuring an actual temperature of water, signal lines for sending a value measured by the temperature detecting sensor to a circuit, and a terminal for protecting the signal lines. The temperature detecting sensor is a thermistor.

In addition, the hollow space of the chamber cap 13 preferably is filled with a heat insulating material in order to reliably fasten the temperature measuring part to the hollow chamber cap 13 as well as to prevent the heat conduction into the surrounding circuits. An example of the heat insulating material preferably includes an epoxy resin.

Hereinafter, the water temperature sensor using the hollow chamber cap 13 is explained in more detail with reference to the drawing.

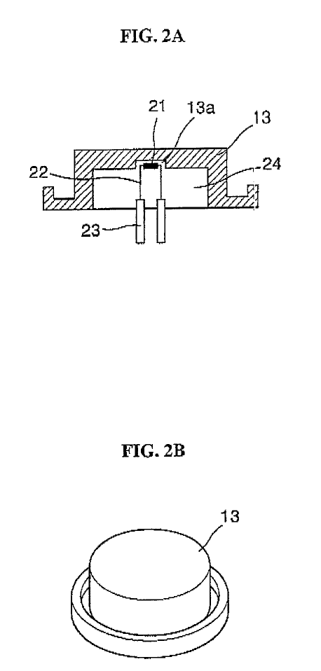

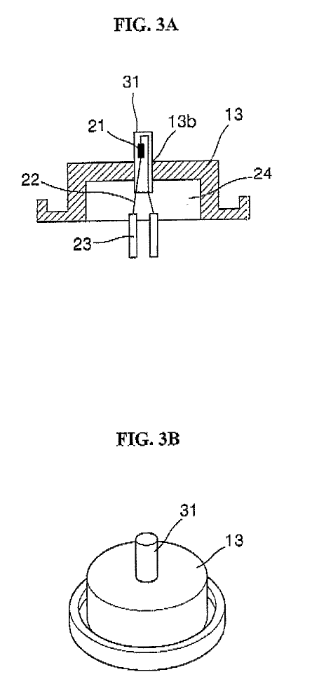

FIG. 2a is a longitudinal sectional view illustrating the water temperature sensor of indirect contact type in accordance with the preferred embodiment of the present invention, and FIG. 3b is a perspective view illustrating the water temperature sensor of indirect contact type in accordance with the preferred embodiment of the present invention.

As shown in FIG. 2a, the water temperature sensor of indirect contact type includes the temperature measuring part and the hollow chamber cap 13. The temperature measuring part includes the temperature detecting sensor 21 for measuring the temperature of water, and the signal lines 22 for connecting the temperature detecting sensor 21 with the circuit requiring the measured value. The hollow chamber cap, locate don the bottom edge of the water gauge chamber, is formed with a recess as a scating portion 13a underneath the top surface thereof so that the temperature measuring part can be mounted within the hollow chamber cap without directly contacting with the washing water.

Particularly, the temperature measuring part further includes the terminal 23 for protecting the signal lines 22 disposed between the temperature detecting sensor 21 and the circuit requiring the measured value (not shown).

The temperature detecting sensor 21 is mainly a thermistor as a semiconductor device produced by mixing and sintering oxides including manganese, nickel, copper, cobalt, chromium, iron and so on. The thermistor shows a considerable variation of electric resistance depending on the temperature. Namely, the temperature increase, the value of electric resistance reduces.

In addition, the signal lines 22 are produced with the temperature detecting sensor 21 assembled. The signal lines serve to connect the temperature detecting sensor 21 with the circuit requiring the measured value )not shown).

Also, the terminal 23 serves to protect the signal lines 22 having a small diameter. In fact, the terminal is a substantial connection part with the circuit.

Meanwhile, the chamber cap 23 is disposed on the lower part of the water gauge chamber formed with a water gauge sensor to prevent the water leakage, and mainly made of a same material with the outer tub. The hollow chamber cap is formed with the seating portion 13a underneath the top surface thereof, which seating portion has a size suitable for reliably receiving the water detecting sensor 21. Also, by adopting the seating portion, the thickness of the hollow chamber cap is reduced, consequently a distance between the water detecting sensor and the washing water can be reduced. This ensures that the heat conduction toward the temperature detecting sensor 21 through the chamber cap 13 is more effectively achieved.

Preferably, the interior part of the water temperature sensor includes the temperature measuring part and the chamber cap 13, namely the hollow space of the chamber cap 13 is filled with the heat insulating material 24. By virtue of the heat insulating material, the temperature measuring part can be more firmly fixed, and it is possible to prevent the heat conduction toward the circuit requiring the measured value (not shown) via the adiabatic action thereof.

The heat insulating material 24 is preferably epoxy resin.

As can be seen in FIG. 2b, since the temperature measuring sensor 21 is installed within the plastic chamber cap 13 to measure the temperature of water via the chamber cap 13 to be contacted with the water, it is self-evident that an error will be generated. Therefore, the value measured by the temperature detecting sensor 21 must be compensated in the circuit requiring the measured value (not shown).

FIG.3a is a longitudinal sectional view illustrating a water temperature sensor of direct contact type in accordance with a preferred embodiment of the present invention, and FIG. 3b is a perspective view illustrating the water temperature sensor of direct contact type in accordance with the preferred embodiment of the present invention.

As can be seen in FIG. 3a, the water temperature sensor of direct contact type in accordance with the present invention also includes the temperature measuring part and the hollow chamber cap 13. The temperature measuring part includes the temperature detecting sensor 21 for measuring the temperature of water, the signal lines 22 for connecting the temperature detecting sensor 21 with the circuit requiring the measured value, and a cylindrical probe 31 containing the temperature detecting sensor and the signal lines. The hollow chamber cap, located on the bottom edge of the water gauge chamber, is drilled with a hole as a seating portion 13a at the center thereof so that the cylindrical probe of the temperature measuring part can directly contact with the washing water after penetrating the hole.

Specially, the temperature measuring part further includes the terminal 23 for protecting the signal lines 22 disposed between the temperature detecting sensor 21 and the circuit requiring the measured value (not shown).

Here, the cylindrical probe 31 is a member actually contacting with water, and substantially contains the temperature detecting sensor 21 and the signal lines 22. The cylindrical probe is made of anti-corrosive material against water, and preferably is made of stainless material having a good heat conduction character.

Since other parts except the cylindrical probe 31 are same with those of the water temperature sensor of indirect contact type, their explanation is omitted.

Meanwhile, the chamber cap 13 has the seating portion 13b of hole shape at the center of the top surface thereof so that the cylindrical probe 31 containing the temperature detecting sensor 21 and the signal lines 22 can be seated. The one end of the cylindrical probe 31 is exposed to the washing water after penetrating the seating portion 13b, and the other end thereof, from which the signal lines 22 are extracted, is located within the chamber cap 13. Of course, the seating portion 13b has to be sealed for waterproofing.

The signal lines 22 extracted from the cylindrical probe 31 are fastened with the terminal 23.

Also, the heating insulating material 24 is inserted into the hollow space of the chamber cap 13 due to the same reason with the water temperature sensor of indirect contact type.

As shown in FIG. 3b, the cylindrical probe 31 containing the temperature detecting sensor 21 is exposed from the top surface of the chamber cap 13 to contact with the water. Since the cylindrical probe is made of a stainless material having a high heat conduction rate, the value of the water temperature measured via the cylindrical probe is almost similar with the actual water temperature. Of course, it is preferable to have a compensation step in order to more accurate value.

As stated above, the sealing between the cylindrical probe 31 and the chamber cap 13 is surely required to prevent the water leakage from the chamber cap 13.

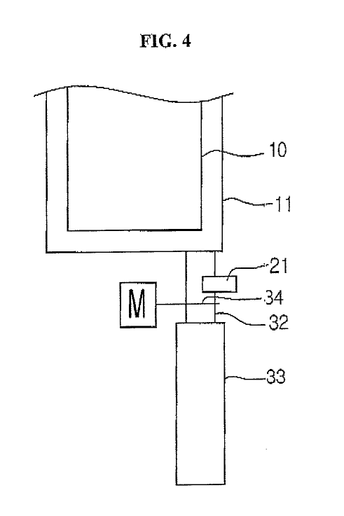

As shown in FIG. 4 in accordance with another embodiment of the present invention, the outer tub 11 containing an inner tub 10 is connected to a drain connector 31 on the bottom edge thereof, and the lower end of the drain connector 32 is connected to a flexible hose 33 for guiding the discharge of the washing water. A valve 34 designed to be opened and closed by the actuation of a motor M is installed on the drain connector 32 for discharging the washing water in the outer case tub 11. The temperature detecting sensor 21 is provided over the valve 34, thus the temperature detecting sensor can measure the temperature of water up the valve when the valve 34 is closed.

Now, a measuring process of the water temperature using the temperature detecting sensor 21 is explained. The valve installed on the drain connector 32 is remained in closed state by the motor M in order to prevent the discharge of the washing water. In this situation, the temperature detecting sensor 21 is able to measure the temperature of the washing water collected over the valve 34. Namely, it is possible to measure the temperature of the washing water even if the temperature detecting sensor 21 is installed within the drain connector 32 connected to the outer tub 11.

As stated above, since the temperature measuring part of the water temperature sensor is mounted within the chamber cap leveled to the bottom surface of the outer tub, it is possible to accurately measure the temperature of the water actually used in washing, thereby the effective and reliable washing being achieved.

In addition, since it is possible to accurately measure the water temperature only by processing the chamber cap without requiring a separate process, the assembly thereof can be simplified and the cost of production can be reduced.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A water temperature sensor comprising:
a temperature measuring part for measuring a temperature of water ;and
a hollow chamber cap located at the bottom edge of a water gauge chamber within a washing machine, having a seating portion on a predetermined place for installing the temperature measuring part.

2. The water temperature sensor of claim 1, further comprising a heat insulating material inserted into a hollow space thereof to achieve an adiabatic effect and to fasten said temperature measuring part within said chamber cap.

3. A water temperature sensor comprising:
a temperature measuring part including a temperature detecting sensor for measuring the temperature of water, and signal lines for connecting the temperature detecting sensor with a circuit requiring the measured value; and
a hollow chamber cap located at the bottom edge of the water gauge chamber, having a recess underneath the top surface thereof to mount the temperature measuring part within the hollow chamber cap, so that the water temperature is measured without directly contacting with water.

4. The water temperature sensor of claim 3, further comprising a heat insulating material inserted into a hollow space thereof to achieve an adiabatic effect and to fasten said temperature measuring part within said chamber cap.

5. A water temperature sensor comprising:
a temperature measuring part including a temperature detecting sensor for measuring the temperature of water, signal lines for connecting the temperature detecting sensor with a circuit requiring the measured value, and a cylindrical probe containing the temperature detecting sensor and the signal lines; and
a hollow chamber cap, located on the bottom edge of the water gauge chamber, having a hole at the center thereof so that the cylindrical probe of the temperature measuring part is directly contacted with the washing water after penetrating the hole.

6. The water temperature sensor of claim 5, further comprising a heat insulating material inserted into a hollow space thereof to achieve an adiabatic effect and to fasten said temperature measuring part within said chamber cap.

7. A washing machine comprising:
an outer tube of a washing machine;
a drain connector connected to said outer tub;
a valve connected to said drain connector, for opening and closing by a motor; and
a sensor installed between said outer tub and the upper side of said valve, for directly measuring the temperature of washing water collected upstream of said valve when said vale is closed.
